(19) United States
(12) Patent Application Publication
(10) Pub. No.: US 2005/0154548 A1
(43) Pub. Date: Jul. 14, 2005

(54) Method for calibration of a 3D measuring device

(76) Inventors: Markus Basel, Neubeuern (DE); Bertram Kaupert, Oberaudorf (DE); Armin Maidhof, Rohrdorf (DE); Frieder Petri, Stephanskirchen (DE); Matthias Prams, Raubling (DE)

Correspondence Address: DILWORTH & BARRESE, LLP, 333 EARLE OVINGTON BLVD., UNIONDALE, NY, 11553, US

(21) Appl. No.: 10/979,653

(22) Filed: Nov. 1, 2004

(30) Foreign Application Priority Data
Oct. 31, 2003 (DE) 103 50 861.9

(51) Int. Cl. G01D 18/00

(52) U.S. Cl. 702/94

(57) ABSTRACT

A method is used to calibrate a 3D measuring device (1). In order to calibrate any 3D measuring device (1) without specific manufacturer's know-how, one or more characterizing objects (15, 16, 17) of a reference object (14) are measured at one or more positions in measurement volume (12) of 3D measuring device (1) to be calibrated. A gauge of the measurement error is calculated from the measured values as a function of the position in measurement volume (12). From that, an error correction function is calculated (FIG. 3).

The invention relates to a method for calibrating a 3D measuring device and a method for determining the 3D coordinates of a measured object using a 3D measuring device.

The 3D measuring device may, in particular, be a tracking system. Optical tracking systems are especially suitable. In particular, the optical tracking system may be coupled with a scanner, for instance a laser line scanner, or with a mechanical feeler. However, the invention can also be realized with a tracking system that works on the basis of a laser beam and its deflection. Furthermore, the invention can also be realized with a tracking system that works non-optically, for instance a tracking system based on other electromagnetic radiation similar to the GPS system. In general, non-contact tracking systems of all kinds are suitable.

In order to achieve great precision, 3D measuring devices must be calibrated. Methods for doing this are known in the prior art, but they can only be carried out if the model parameters of the 3D measuring device are known. However, in practice this prerequisite is not always fulfilled.

If the 3D measuring device is a conventional 3D measuring machine with tactile or optical sensors, then the following procedure can be used for the calibration: Using interferometric length measurements, scale values are determined for incremental sensors placed along the axes of the 3D measuring machine. The angles at which the axes are positioned, and which generally will be near to 90°, are determined using angle gauge blocks. The precise 3D dimensions can be verified using certified reference objects, for instance spherical rulers or length gauge blocks. Methods are also known in which a regular grid of points in space is created, the ideal position of the points in relation to the actual position of the points is determined, and from that the model parameters are determined. With this method, the calibration usually takes several days, and possibly even weeks. Expensive interferometric measuring systems are required.

If the 3D measuring device to be calibrated is a tracking system, for example an optical, electronic, or other tracking system, the following procedure can be followed: A reference object is moved along a regular grid of points in space, for example using a high-precision handling system, in particular a coordinate measuring machine, and the position of the reference object from the point of view of the tracking system is ascertained and stored. The model parameters are then determined from the measurement value pairing of the ideal values and the actual values. In this case, too, the calibration takes a very long time, typically one to several days. A very expensive, high-precision handling system that encompasses the measured volume is required.

If the 3D measuring device consists of optical surface sensors or volume sensors (imaging sensors, photogrammetry systems), the calibration can be performed in the following way: Using the sensors, a large number of images are taken of certified rulers or planar or three-dimensionally shaped test objects. Precalibrated characteristics clearly identifiable by the measuring system are located on the test objects. The model parameters of the sensor system are determined in a complex mathematical procedure, for example a bundle adjustment with spatial resection. In this case, the calibration of the measuring system is typically carried out on site by the user. In this process only very small measurement volumes can be covered, however.

EP 0 452 422 B 1 discloses a method for calibrating a sensor of a three-dimensional shape detection system.

DE 100 23 604 A1 discloses a one-dimensional calibration standard for optical coordinate measuring devices that encompasses a rod-shaped calibration tool.

U.S. 2003/0038933 A1 discloses a method for calibrating a 3D measuring device in which several characterizing objects are measured and a gauge of the measurement error is calculated.

The object of the invention is to propose a method for calibrating a 3D measuring device by means of which any 3D measuring device can be calibrated without specific manufacturer's know-how. Another object of the invention consists in proposing an improved method for determining the 3D coordinates of a measured object using a 3D measuring device.

This task is solved according to the invention through the characteristics of claim 1. According to the method, one or more characterizing objects of a reference object are measured at one or more positions in the measurement volume of the 3D measuring device to be calibrated. Based on the measured values, a gauge of the measurement error is calculated as a function of the position in the measurement volume of the 3D measuring device. From that, an error correction function is calculated. This is an error correction function that corrects the error as a function of the position in the measurement volume. The calculated error correction function can be stored in memory. It is available for subsequent measurements in which the 3D measuring device is used. The values recorded in these measurements can be corrected using the error correction function. Advantageous further developments are described in the dependent claims.

The reference object and with it the characterizing object(s) can be moved within the measurement volume. This can be done by hand. However, it can also be done by automated and/or mechanical means. The reference object is moved to all positions required in order to calculate the error correction function. Instead of that, or in addition to that, it is also possible to move the 3D measuring device.

However, it is also possible to measure the reference object statically, thus not to move it within the measurement volume, if the reference object has several characterizing objects that cover all the positions necessary in order to calculate the error correction function. In this case, too, as provided in claim 1, several characterizing objects are measured at several positions in the volume of the 3D measuring device to be calibrated.

Another advantageous further development is characterized in that the characterizing object(s) of the reference object are not precisely known. Thus none of the characterizing objects is precisely known or certified. In this case, a relative error correction function can be calculated.

According to another advantageous further development, one or more or all of the characterizing object(s) of the reference object are precisely known or certified. In this case, an absolute error correction function can be calculated.

Another advantageous further development is characterized in that the error correction function is scaled. This is particularly advantageous if the characterizing object(s) of the reference object are not precisely known. In this case, an absolute error correction function can be calculated from the relative error correction function by means of the scaling. The scaling can be done especially by means of a one-time measurement at only one position of the measurement volume using a precisely known or certified characterizing object or reference object. Thus it is not necessary to move a precisely known or certified reference object or characterizing object within the entire measurement volume. The movement across the entire measurement volume can be carried out with a characterizing object or reference object that is not precisely known or certified, in order to obtain a relative error correction. Then this relative error correction function can be easily scaled by carrying out a one-time measurement at only one position of the measurement volume using a precisely known or certified reference object or characterizing object. However, it is also possible to measure the precisely known or certified reference object or characterizing object at several positions of the measurement volume. In this case, a better scale value can be calculated by taking the mean of several results. It is not impossible, but possible, although in general not necessary, to scale the error correction function if one or more or all of the characterizing object(s) of the reference object are precisely known or certified.

As a gauge for the measurement error, the standard deviation or the median or maximum deviation of the best-fit alignment can be used in particular. Likewise, other mathematical adjustment methods can be used. However, not only polynomials are suited as error correction functions, but also splines, error correction tables, or any combinations thereof.

Another advantageous further development is characterized in that the reference object and/or the characterizing object(s) are made of a material that is temperature-invariant.

Another advantageous further development is characterized in that the positions at which the characterizing object(s) are measured are representative and/or evenly spaced in the measurement volume. If, during the recording of the characterizing objects or of the movement of the reference object in the measurement volume, attention is paid to a representative distribution in the measurement volume and/or one that is as evenly spaced as possible, then the error correction function can be determined especially well. Then it will deliver a particularly good result.

The task underlying the invention is solved furthermore by a method for determining the 3D coordinates of a measured object using a 3D measuring device, in which the measured values are corrected using an error correction function as a function of their position in the measurement volume.

It is advantageous if the error correction function has been calculated according to the method according to the invention as described above.

Embodiments of the invention are explained in detail below using the attached drawings.

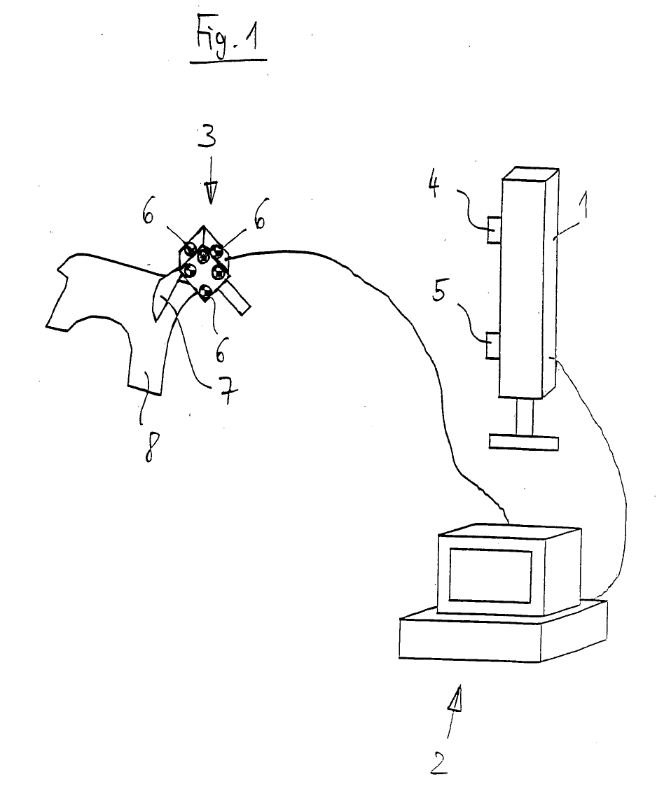

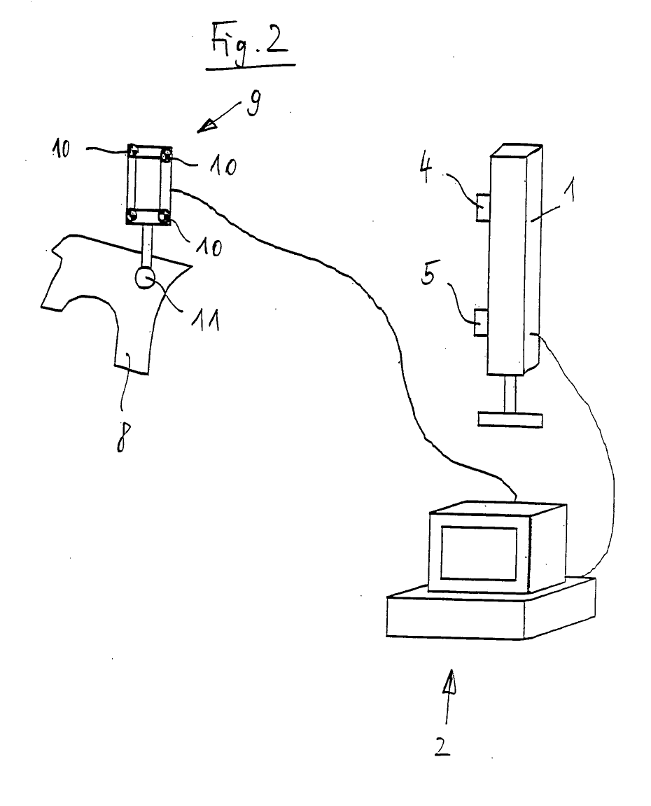

FIG. 1 shows an optical tracking system with a laser line scanner in a schematic view FIG. 2 shows an optical tracking system with a mechanical feeler in a schematic view,

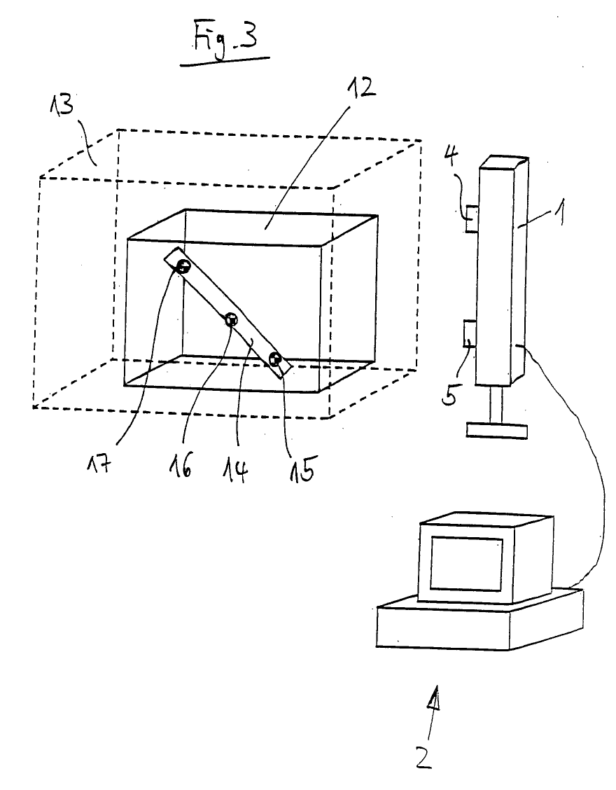

FIG. 3 shows the optical tracking system of FIG. 1 or 2 with a reference object,

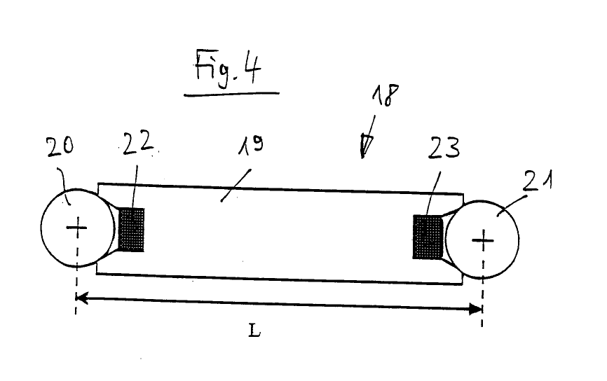

FIG. 4 shows a reference object designed as a ball rod in a side view,

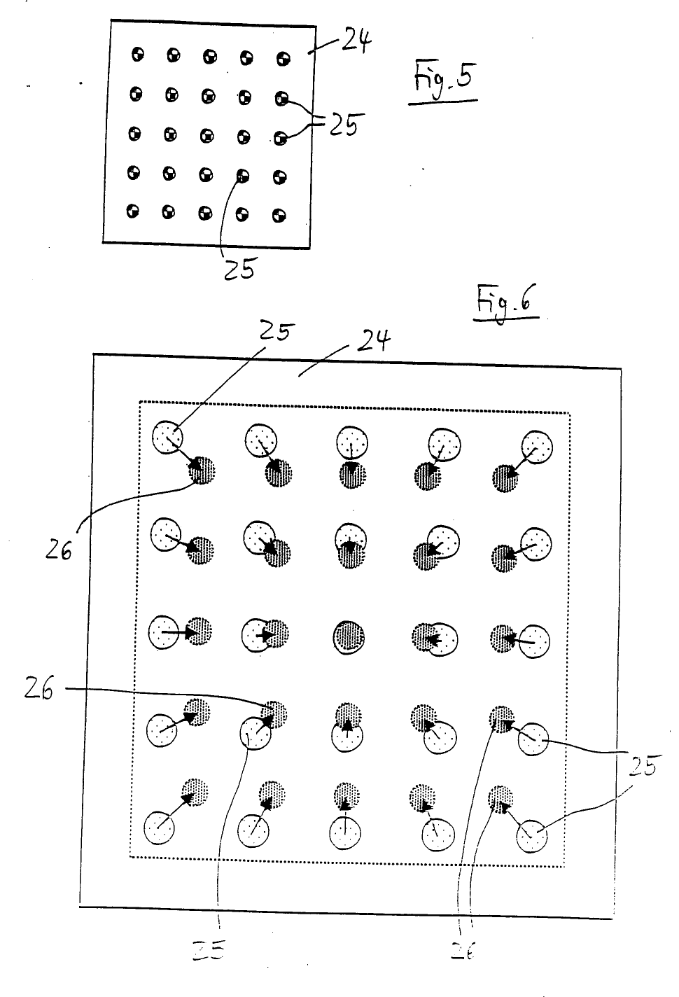

FIG. 5 shows a reference object with a number of LEDs in a front view and

FIG. 6 shows the reference object of FIG. 5 with schematically indicated measured values.

Optical tracking system 1 shown in FIG. 1 is coupled with a laser line scanner 3 through a computer 2, for example a PC. Optical tracking system 1 encompasses two sensors 4, 5, preferably CDD sensors, with corresponding optics. LEDs 6 are distributed on all sides of the casing of laser line scanner 3, in such a way that at least three of LEDs 6 can be seen by sensors 4, 5 of optical tracking system 1 at every position of laser line scanner 3. LEDs 6 are turned on in quick succession consecutively or simultaneously and give off a brief flash of light or emit continuously. Sensors 4, 5 of optical tracking system 1 register every light flash and calculate from that a 3D coordinate for the respective flashing LED 6. In this way, the spatial position and orientation of laser line scanner 3 can be determined without ambiguity. Laser line scanner 3 is calibrated in advance so that the position of laser light line 7 emitted by it is known very precisely in relation to the position of LEDs 6. Thus, based on the 3D coordinates of LEDs 6, the 3D position and orientation of laser light line 7 can be precisely derived. By passing over the entire surface of an object 8, for example a motor vehicle component, a very dense cloud of measured points on the component surface can be recorded and stored in computer 2.

FIG. 2 shows a modification of the system of FIG. 1, in which laser line scanner 3 is replaced by a mechanical feeler 9 that is coupled with optical tracking system 1 through computer 2. Four LEDs 10 are attached to mechanical feeler 9. The minimum number of LEDs is three, while preferably four to ten LEDs are used. LEDs 10 are turned on consecutively in quick succession and each give off a brief flash of light. Sensors 4, 5 of optical tracking system 1 register every light flash and calculate from that a 3D coordinate for the respective LED 10. Mechanical feeler 9 is calibrated in advance so that the center of its feeler spheres 11 is known very precisely in relation to the position of LEDs 10. Instead of feeler sphere 11, a feeler point can also be used, namely a sphere of very small radius. Thus, based on the 3D coordinates of LEDs 10, the 3D coordinates of the center of feeler spheres 11 can be derived. Mechanical feeler 9 is conveyed by hand to various points on object 8 to be measured, in such a way that its feeler spheres 11 touch the surface of object 8. The 3D coordinates of the center of feeler spheres 11 are determined in this way. They can be stored in computer 2.

FIG. 3 shows a set-up for calibrating optical tracking system 1 of FIGS. 1 and 2. Optical tracking system 1 is to be calibrated for measurements within a measurement volume 12, that lies within the largest possible measurement volume 13 of optical tracking system 1. A reference object 14 is present in measurement volume 12, encompassing three characterizing objects 15, 16, 17, each of which is formed by an LED. LEDs 15-17 are attached to reference object 14. Reference object 14 is a measuring rod preferably made of a temperature-invariant material.

As the calibration method is carried out, LEDs 15-17 are turned on consecutively in quick succession. They each give off a brief flash of light. Sensors 4, 5 of optical tracking system 1 to be calibrated register every light flash and calculate from that a 3D coordinate for each LED 15-17, namely the position of the respective LED 15-17 in the coordinate system of optical tracking system 1. This can be done by calculating a focus beam on each of sensors 4, 5 from the image of LEDs 15-17 and by determining the spatial coordinates of LEDs 15-17 from the intersection of two paired beams. Based on the spatial coordinates of LEDs 15-17, distance values can be calculated for each pair, thus the distance values 15-16, 15-17, and 16-17.

If reference object 14 is a certified reference object, namely a reference object in which the positions of LEDs 15-17 forming the characterizing objects are precisely known, then the distance values [determined] from the positions of LEDs 15-17 can be compared with the real, certified distance values. This comparison furnishes an absolute gauge of the measuring error.

If reference object 14 is a non-certified reference object, namely a reference object in which the positions of LEDs 15-17 are not precisely known, then the distance values determined from the positions of LEDs 15-17 can be compared with the assumed distance values. This comparison furnishes a relative gauge of the measurement error.

Reference object 14 is then brought into another position in the portion of measurement volume 12 to be calibrated. There the process just described is repeated. The entire process is carried out for a sufficient number of positions in measurement volume 12. In this way, a gauge of the measurement error is obtained from the measured values as a function of the position in measurement volume 12. The calibration can also be carried out in the largest possible measurement volume 13.

At every position at which reference object 14 is found, the 3D coordinates of LEDs 15-17 are measured in pairs using optical tracking system 1, and from that the distance values are calculated. Meanwhile, reference object 14 can be held in a statically fixed position during the measurement. But it can also be moved dynamically during the measurement, if its velocity of motion is slow compared to the recording rate of the LEDs. In order to accelerate the calibration process, it is advantageous if reference object 14 is moved as fast as reasonable in measurement volume 12. Reference object 14 is brought into so many different positions of measurement volume 12 that respective measured 3D coordinates of LEDs 15 to 17 exist for all portions of the entire measurement volume. The size of the portions of measured volume 12, for which respective measured values of the 3D positions exist, can be selected according to the required precision and according to the error correction function applied.

Finally, an error correction function is calculated, namely from the gauge of the measurement error that is calculated as a function of the position in the measurement volume. The distance values calculated according to the described method are compared with the certified distances (if it is a certified reference object 14) or with the assumed distances (if it is a non-certified reference object 14). For every measured distance value, an absolute measurement error in the case mentioned first, and a relative measurement error in the case mentioned second, is obtained that is attributed to that portion of measurement volume 12 in which reference object 14 or affected LEDs 15-17 were found during the measurement.

The error correction function can be set up as a polynomial. The coefficients or model parameters of the error correction functions designed as a polynomial or other function can be changed in an iterative procedure in such a way that the absolute or relative measurement error is gradually minimized, thus comes to be near zero, through application of the correction function to the measured positions of the LEDs and renewed calculation of the distances. For example, the method of least error squares can be deployed as a mathematical optimization method.

Preferably the distances of LEDs 15-17 on reference object 14 are precisely known, that is, certified. In this case, absolute measurement errors exist in the described procedure, which can be minimized according to the described method in order to obtain the error communication function. This will result in a calibrated optical tracking system.

If a non-certified reference object 14 is used, the method is likewise carried out as described. As comparison values for the distance values between LEDs 15-17, estimated or roughly measured distance values are used. As a result, only relative measurement errors are obtained in the comparison of the distance values. From this an error correction function is obtained that minimizes the relative measurement errors. This can lead for instance to equal distances being measured everywhere in measurement volume 12, but with all of them diverging from the accurate value by a certain factor. Therefore, it is necessary to make the relative measurement precision into an absolute measurement precision using a scaling factor.

For this purpose, a certified reference object is measured at one or more places in measurement volume 12.

For example, the certified reference object can be a ball rod 18 of the kind shown in FIG. 4. It consists of an oblong object 19, at both ends of which is a truncated cone shaped receptacle, each of which holds one measuring sphere 20, 21. Measuring spheres 20, 21 are held in their receptacles by permanent magnets 22, 23. Length L of ball rod 18, which is equal to the distance between the centers of measuring spheres 20, 21, is very precisely known. Thus ball rod 18 can be very precisely certified.

The scale value is calculated from the coefficient of certified length L to the length as measured by optical tracking system 1. This scale value must be determined at only one place in measurement volume 12, thus at only one position of ball rod 18. It can then be applied to all measured points of optical tracking system 1. If the relative error correction function is first applied to all measured points of optical tracking system 1, and if the values determined in this way are then multiplied by the scale value, then absolute, very precise 3D coordinates will be obtained.

The 3D coordinates of LEDs 15-17 recorded by optical tracking system 1 may show a high level of measurement value noise. Thus the measured distance values can be very greatly scattered, so that, since only the sum of measurement errors and noise quota is ever measured, the absolute or relative measurement error cannot be calculated with sufficient precision. In order to alleviate this, reference object 24 shown in FIG. 5 can be used, which has a large number of LEDs 25, namely twenty-five. The 3D positions of LEDs 25 are measured with an additive noise quota using optical tracking system 1. In a subsequent procedural step, the measured 3D positions are represented in a best-fit alignment on top of certified positions 26 (if reference object 24 is certified) or assumed positions 26 (if reference object 24 is not certified) of reference object 24.

An example of this procedural step is presented in FIG. 6. The statistical key figures of the best-fit alignment—in particular the median deviation, that is, the median value of the imaging errors, or the standard deviation—are a gauge for the measurement error. If reference object 24 is subsequently measured at many positions in measurement volume 12 as described above, then the distribution of the measurement value errors is obtained and the error correction function can be calculated as described above.

The invention makes it possible to calibrate any 3D measuring device without specific manufacturer's know-how. For this purpose, a suitable reference object for the respective 3D measuring device, for example a measuring rod, a measuring plate, or a measuring object of complex shape, is brought into different positions within the measurement volume to be calibrated, which may be equivalent to the largest possible measurement volume, and is measured at the respective position using the 3D measuring device. Using the deviations of the measured characterizing objects compared to absolute (certified) or relative (specified/assumed) gauges of the reference object, or using the scatter pattern of the measured characterizing objects, an error correction function can then be calculated.

By the use of this error correction function, it then becomes possible to correct any measured value of the 3D measuring device so that an improved, nearly error-free measurement value is obtained.

The method according to the invention can be carried out without the involvement and/or without using the know-how of the manufacturer of the 3D measuring system. It is possible to use simple and inexpensive reference objects. The calibration can be carried out by the user on site. Depending on the 3D measuring device, it can be carried out very quickly, so that it is possible to use it repeatedly, for example to compensate for temperature, to guarantee precision of measurement, or for similar purposes. According to the invention, a reference object can be used that is designed as simply as possible, having at least one characterizing object that can be measured precisely, easily, and quickly with the 3D measuring device to be calibrated. In conventional 3D coordinate measuring machines, this can be, for example, a sphere, a part of a sphere, a cone, or something similar. In optical tracking systems, this can be, for example, a mark, preferably one that is identifiable by automated means, an active light-emitting diode, or something similar. The decisive issue is that an unambiguous characteristic can be identified on the reference object by means of each characterizing object, in the simplest case a 3D point (in relation to a coordinate system arbitrarily fixed on the reference object). But there can also be more than one characteristic, for example point and direction, point and diameter, point and direction and dimension, or something similar. This is based on the idea that these characteristics include at least one motion and rotation-invariant characteristic, or that a motion and rotation-invariant characteristic can be derived from the combination of at least two characteristics, the measured quality of which by contrast to its actual quality allows for derivation of the measurement error.

In the simplest case, the reference object consists of a rod with two characterizing objects, each of whose unambiguous position is identified by a 3D point, from which a distance between the points can be calculated. During the measurement of such a reference object using the 3D measuring device to be calibrated, each characterizing object is measured and the measured distance is calculated from that. It is then possible to compare the measured distance with the actual distance and derive a gauge for the measurement error from that. It is also conceivable to use a reference object with only a single characterizing object. If the characterizing object is realized with a sphere or a part of a sphere, the diameter of the sphere can be measured with the 3D measuring device to be calibrated. It is then possible to compare the measured diameter with the actual diameter and derive a gauge for the measurement error from that. However, it is also possible to use a reference object with many characterizing objects. In this case, every characterizing object is measured with the 3D measuring device to be calibrated.

Different possibilities for assessing the measurement error are feasible, in particular the following:

(1) The measured 3D points of the characterizing objects affected by errors and located in the coordinate system of the 3D measuring device are represented in a best-fit alignment on top of the actual position of the characterizing objects present in an arbitrarily selected coordinate system fixed to the reference object. The level of quality of this alignment is a gauge of the measuring error. For example, the standard deviation of the best-fit alignment, the median error, or the maximum occurring error or something similar can be used. In the best-fit alignment, characteristics like direction, diameter, and dimension of the characterizing objects can also be taken into account.

(2) Distances between pairs of measured 3D points of the characterizing objects can be calculated. These distances can be compared with the actual distances, and a gauge for the measurement error can be derived from that, for example by taking the mean of the distance measurement errors. However, it is also possible to take the individual distance measurement errors into account. Since they occur at different places on the reference object and thus at different places in the measurement volume of the 3D measuring device, the position-related quality of the measurement error can be derived from them.

(3) From the measured 3D points of the characterizing objects, a triangle can be calculated from every set of three characterizing objects. The shape or surface area of each triangle can be compared with its actual quality. A gauge for the measurement error can be derived from that.

(4) Alternatives (1)-(3) can be combined in any desired fashion.

The positions and number of measurements will preferably be determined so that the calculated measurement errors are distributed in a representative fashion in the measurement volume of the 3D measuring device. It is conceivable that a reference object of complex design, having a sufficient number of characterizing objects, might be measured at only one position in the measurement volume, that a sufficient number of gauges for the measurement error at different places in the measurement volume might be obtained from this, and that the distribution of measurement errors of the 3D measuring device might be described thereby in representative fashion.

It is likewise conceivable that a simple reference object, that with each measurement furnishes only one gauge for the measurement error, might be measured at several or even many positions in the measurement volume, and that the distribution of the measurement errors of the 3D measuring device might be described thereby in representative fashion.

It is likewise conceivable that a reference object of complex design with a certain number of characterizing objects that cover only a portion of the measurement volume might be measured at several or even many positions in the measurement volume, so that several gauges for the measurement error are obtained by each of the repeated measurements, in order that the distribution of the measurement errors of the 3D measuring device might be described thereby in representative fashion.

By moving the reference object dynamically through the measurement volume during the measurement, the calibration process can be significantly speeded up. This would require that a fast-measuring 3D measuring device, such as a tracking system, be used. Meanwhile, the movement must be slow relative to the measuring speed of the 3D measuring device.

The invention is based on the idea that an error correction function can be calculated using a mathematical procedure from the representative distribution of the gauges for the measurement error of the 3D measuring device to be calibrated. By the use of this error correction function, it then becomes possible to correct any measured value of the 3D measuring device based on the error correction function, so that an improved, less error-prone measurement value is obtained.

The type of error function used can be adapted to the measurement error distributions typically occurring with the respective 3D measuring device. The error correction function can be represented by a simple mathematical function, for example, a function based on polynomials. However, it can also be designed to be as complicated as desired; for example, it can be designed as a function based on splines. The error correction function can be also represented by a table of correction values. It is also conceivable to combine simple or complex functions with a table of correction values. For the method according to the invention, it is generally irrelevant what mathematical procedure is used to calculate the error correction function. It might consist of analytic solution approaches, iterative methods, optimization algorithms or something similar.

If absolutely exact measurement errors are to be used, it is necessary that at least one characteristic of the reference object be precisely known. This is typically ensured by certification of the reference object. In this case, the error correction function provides precise measurement values directly.

If relative measurement errors are to be used, the fact that the reference object always has the same shape can be exploited to advantage. The calculated error correction function supplies measurement values that result in precise values only after additional application of a scale value. This scale value can be calculated by measurement of a known standard test object in one position. However, it is also possible to measure the standard test object in several positions in order to obtain the scale value.

1. Method for calibrating a 3D measuring device (1),
characterized in that
one or more characterizing objects (15, 16, 17, 25) of a reference object (14; 24) are measured at one or more positions in measurement volume (12) of 3D measuring device (1) to be calibrated,
that a gauge of the measurement error is calculated as a function of the position in measurement volume (12),
and that an error correction function is calculated from that.

2. Method of claim 1, characterized in that reference object (14; 24) in measurement volume (12) is moved and that the 3D measuring device is moved.

3. Method of claim 1, characterized in that characterizing object(s) (15, 16, 17; 25) of reference object (14; 24) are not precisely known.

4. Method of claim 1, characterized in that one or more or all characterizing object(s) (15, 16, 17; 26) of reference object (14; 24) are precisely known.

5. Method of claim 1, characterized in that the error correction function is scaled.

6. Method of any of the preceding claims claim 1, characterized in that the standard deviation or the median or maximum deviation of the best-fit alignment can be used in particular as a gauge for the measurement error.

7. Method of claim 1, characterized in that reference object (14; 24) and/or the characterizing object(s) are made of a material that is temperature-invariant.

8. Method of claim 1, characterized in that the positions at which characterizing object(s) (15, 16, 17; 25) are measured are representative and/or evenly spaced in measurement volume (12).

9. Method for determining the 3D coordinates of a measured object (8) using a 3D measuring device (1), characterized in that the measured values are corrected using an error correction function as a function of their position in measurement volume (13).

10. Method of claim 9, characterized in that the error correction function has been calculated according to a method of
measuring one or more characterizing objects (15, 16, 17, 25) of a reference object (14, 24) at one or more positions in measurement volume (12) of 3D measuring device (1) to be calibrated, and
calculating a gauge of the measurement error as a function of the position in the measurement volume (12).

11. Method of claim 2, characterized in that one or more or all characterizing object(s) (15, 16, 17; 26) of reference object (14; 24) are precisely known.

12. Method of claim 2, characterized in that the error correction function is scaled.

13. Method of claim 3, characterized in that the error correction function is scaled.

14. Method of claim 4, characterized in that the error correction function is scaled.

15. Method of claim 11, characterized in that the error correction function is scaled.

16. Method of claim 2, characterized in that the standard deviation or the median or maximum deviation of the best-fit alignment can be used in particular as a gauge for the measurement error.

17. Method of claim 3, characterized in that the standard deviation or the median or maximum deviation of the best-fit alignment can be used in particular as a gauge for the measurement error.

18. Method of claim 4, characterized in that the standard deviation or the median or maximum deviation of the best-fit alignment can be used in particular as a gauge for the measurement error.

19. Method of claim 5, characterized in that the standard deviation or the median or maximum deviation of the best-fit alignment can be used in particular as a gauge for the measurement error.

20. Method of claim 11, characterized in that the standard deviation or the median or maximum deviation of the best-fit alignment can be used in particular as a gauge for the measurement error.
